(19) United States
(12) Patent Application Publication
(10) Pub. No.: US 2026/0236158 A1
(43) Pub. Date: Aug. 13, 2026

(54) CONTEXT-SENSITIVE INERTIAL SCROLLING METHOD AND APPARATUS

(71) Applicant: Viktor Kaptelinin, Hörnefors (SE)

(72) Inventor: Viktor Kaptelinin, Hörnefors (SE)

(21) Appl. No.: 19/535,982

(22) Filed: Feb. 10, 2026

Related U.S. Application Data
(60) Provisional application No. 63/756,562, filed on Feb. 10, 2025.
(60) Provisional application No. 63/838,836, filed on Jul. 5, 2025.

(51) Int. Cl. G06F 3/0485; G06F 3/04883

(52) U.S. Cl. CPC G06F 3/0485; G06F 3/04883

(57) ABSTRACT

A computer-implemented method and apparatus are disclosed for supporting inertial scrolling of content displayed in a window on an electronic device. The method automatically selects between dynamics-independent inertial scrolling and dynamics-dependent inertial scrolling based on interaction context. Specifically, the selection depends on whether a current inertial scrolling user action is preceded, within a predetermined time threshold and in substantially the same direction, by a prior inertial scrolling. When no such preceding inertial scrolling is detected, a dynamics-independent inertial scrolling is performed, in which scrolling distance is determined independently of momentum-related dynamic parameters of the user action. When such preceding inertial scrolling is detected, a dynamics-dependent inertial scrolling is performed, in which scrolling distance depends on momentum-related dynamic parameters. The disclosed techniques enable context-sensitive scrolling behavior without requiring explicit mode switching by the user.

### CROSS-REFERENCE TO RELATED APPLICATIONS

The present application claims the benefit of provisional U.S. Patent Application Ser. Nr. 63/756,562, filed Feb. 10, 2025, with title “INERTIAL SCROLLING METHOD AND APPARATUS” and naming Viktor Kaptelinin as inventor, and of provisional U.S. Patent Application Ser. Nr. 63/838,836, filed Jul. 5, 2025, with title “INERTIAL SCROLLING METHOD AND APPARATUS” and naming Viktor Kaptelinin as inventor.

### FEDERALLY SPONSORED RESEARCH

Not Applicable

### BACKGROUND OF THE INVENTION

The invention relates to user interfaces of electronic devices. Particularly, the invention relates to supporting the user in viewing various types of content presented on displays of electronic devices. The invention applies to all types of such displays, including screens of personal electronic devices (such as smartphones, tablet computers, laptop computers, or desktop computers), large-screen wall mounted displays, tabletop displays, embedded displays of industrial or consumer equipment, projecting images on various surfaces, head-mounted displays, and smart glasses.

Displays of electronic devices are used to display various types of information objects. The contents of information objects are typically displayed in windows. Only a portion of a window-related content (a “document”) may be displayed in a window, and the user may need to scroll the document to bring into view other portions.

One particular type of scrolling is inertial scrolling, which may also be referred to as “kinetic scrolling”. Inertial scrolling is a scrolling that continues after the user completes a scrolling user action, e.g., breaks contact with a scrolling input device. In inertial scrolling, window content may appear to receive momentum from the user action, such as a flick gesture, which makes the content scroll in the direction determined by the gesture. Inertial scrolling may be achieved by performing a scrolling user action when using a separate input device, such as a touchpad or scroll wheel. Inertial scrolling is commonly implemented so that the scrolling slows down, and eventually stops, after the user breaks contact with the scrolling device.

Inertial scrolling is often implemented as dynamics-dependent, so that dynamics of the user action correlate with the perceived momentum transferred to the scrolled document by the user's scrolling action. The transition of momentum-affecting dynamics of an inertial user action into parameters of inertial scrolling may be implemented differently in different electronic devices and computer applications.

User action's dynamics, such as input object's speed and/or engagement time, may be controlled by the user to achieve desirable inertial scrolling parameters, such as distance and/or speed, by transferring appropriate momentum. For instance, faster flick gestures may result in longer scroll distances.

Inertial scrolling can serve different purposes, including bringing to view the next text fragment when continuously reading a document, viewing a next information unit of a document (such a table, a section, or a social media post), or browsing a document to skim its content or search for a predetermined information unit. These diverse purposes may be best achieved by using different types of scrolling. Dynamics-dependent inertial scrolling may be more suitable for long-distance scrolling, while known dynamics-independent techniques, such as those capping the maximum scrolling distance irrespective of the dynamics of the user action (e.g., US Patent application 18084717) may be more suitable for continuous reading.

In their everyday contexts, viewers of displayed documents may continuously, on a moment-to-moment basis, switch between scrolling a document for different purposes. Explicitly choosing a scrolling technique, optimal for a particular purpose (e.g., continuous reading vs. browsing) may be unfeasible because of potentially excessive overhead. The present invention addresses this problem with prior art.

### SUMMARY OF THE INVENTION

The present invention discloses method and apparatus for supporting inertial scrolling on electronic devices by introducing context-sensitive scrolling behavior. The invention distinguishes between two types of inertial scrolling:

The first type, dynamics-independent, inertial scrolling (DIIS): inertial scrolling for a distance, independent of momentum-related dynamic parameters of the scrolling user action. The scrolling distance is instead based on display geometry, document structure, or user-defined settings, in different embodiments being:
(a) a distance between the window location pointed at by the user when the inertial scrolling user action is initiated and the window's border in the direction of the scrolling; it corresponds to the location-based distance scrolling (LBS) subtype of DIIS,
(b) a predetermined scrolling distance set by the user or inferred through machine-implemented means; it corresponds to the predetermined distance scrolling (PDS) subtype of DIIS, or
(c) a distance needed to display a next information object in the document in the direction opposite to scrolling direction; it corresponds to the next-object scrolling (NOS) subtype of DIIS.

The second type, dynamics-dependent, inertial scrolling (DDIS): inertial scrolling, in which the scroll distance is determined by momentum-related dynamic parameters of the user gesture (e.g., speed), which parameters affect the perceived transfer of momentum to the displayed window content (e.g., a faster gesture may result in a longer inertial scrolling), and is not limited by a predefined value independent of momentum-related dynamic parameters of the user gesture.

According to an aspect of the invention, inertial scrolling behavior caused by an inertial scrolling user action (ISUA) depends on the order of the ISUA in a block of ISUAs, a block of ISUAs being either one ISUA or a series of consecutive ISUAs, so that a predetermined number of initial ISUAs in a block each causes a DIIS, while subsequent ISUA or ISUAs in the block cause DDIS. A current ISUA is considered belonging to the same block as immediately preceding ISUA if the current ISUA is performed in generally the same scrolling direction in less a predetermined amount of time (also referred to as “time threshold”) after the inertial scrolling caused by the preceding ISUA.

In another aspect of the invention, the scrolling distance of a DIIS may depend on (e.g., positively correlate with) the dynamics of the ISUA causing the DIIS until a maximum distance value is achieved, capping further scrolling. For instance, until the scrolling distance reaches a maximum value for a DIIS, faster ISUA may cause scrolling for longer distances, and when this maximum distance is achieved, it may not be exceeded no matter how fast an ISUA is. In other aspects of the invention, a DIIS distance does not depend on ISUA's momentum-related dynamics even for shorter-than-the-limit distances: if an ISUA is detected, then even a low-dynamics (e.g., slower) ISUA would cause a scrolling for the entire predetermined distance value.

In yet another aspect of the invention, a time threshold is used to determine which scrolling type to apply, so that if a recent inertial scroll occurred within that time threshold, a DDIS is performed, while otherwise a DIIS subtype is triggered. A DIIS is performed in response to a current ISUA if no preceding ISUA has taken place within less than the time threshold (a predetermined amount of time) before the current ISUA. A DDIS is performed if another ISUA takes place within the time threshold before the current ISUA. This approach supports both short-distance, precise scrolling (e.g., for continuous reading) and longer navigational scrolling (e.g., for browsing), without requiring the user to manually switch scrolling modes.

In some aspects, a DIIS subtype employed for scrolling in one direction may be different from a DIIS subtype employed for scrolling in another direction. For instance, when a document is scrolled toward the upper window border (“up”), the first ISUA in a block may cause an LBS and the second and potential further ISUAS in the block may cause DDIS, while when the document is scrolled toward the lower window border (“down”), the first ISUA may cause a NOS and the second and potential further ISUAS in the block may cause DDIS.

### BRIEF DESCRIPTION OF THE DRAWINGS

FIG. 1 is a schematic description illustrating a method according to the invention.

FIG. 2 is a schematic description of a method according to the first, second, and third embodiments of the invention, which involves performing a DIIS in response to first ISUA in a block and a DDIS for second and subsequent ISUAs in a block.

FIGS. 3a-3d illustrate a scrolling method according to LBS subtype of DDIS, which involves using a touch screen.

FIGS. 4a-4c illustrate a scrolling method according to LBS subtype of DIIS, which involves using a touch pad.

FIG. 5 illustrates method according to LBS subtype of DIIS, which involves scrolling that has both a horizonal component and a vertical component.

FIG. 6a-6b illustrate a method according to LBS subtype of DIIS, which involves using an area outside the display for scrolling input.

FIG. 7 illustrates a method according to PDS subtype of DIIS, which involves using a touch screen.

FIGS. 8a-8c illustrate a scrolling method according to NOS subtype of DIIS, which involves using a touch screen.

FIGS. 9a-9h illustrate a scrolling method according to the fourth embodiment of the invention, in which a DIIS is performed in response to two initial ISUAs in a block and a DDIS is performed in response to third and subsequent ISUAs in a block, and in which different DIIS subtypes are employed for scrolling in different directions.

### DETAILED DESCRIPTION OF THE INVENTION

### Glossary of Terms

Display (or “screen”): A component of an electronic device, configured to enable visual presentation of electronically stored information. A display can comprise several parts, such as several information displaying devices placed side by side.

Window (or “display window”): In the context of this invention the term is broadly understood as a content viewing area (which may or may not be rectangular) of a display of any type. A window may occupy a sub-area of a display or coincide with an entire display. In the context of this invention, the term “window” refers to content viewing areas displaying scrollable content and may not include areas displaying static non-scrollable, or partly scrollable, or pegged, screen objects such as screen controls or advertisements. “Window border” refers to an effective border of an area displaying scrollable content.

Document: Content displayed in a display window. Unless specifically noted, the terms “document” and “document image” are used here interchangeably.

Scrolling Input Device (or “Input Device”): A device or surface, such as a touch screen, a touch pad, or a scroll wheel, used to initiate scrolling. An input device may be integrated with a display (e.g., a touch screen) or be separate from a display.

Input object: An object, such as a finger, a combination of fingers, or a stylus, used to engage with an input device to perform scrolling.

Inertial Scrolling: Scrolling of a document that takes place after the input object disengages from the input device, simulating momentum.

Inertial Scrolling User Action (ISUA): A user-performed physical action such as a gesture (e.g., flick) which involves an input object's engagement with, and subsequent disengagement from, an input device, that causes inertial scrolling. The direction of scrolling, understood as the direction in which window content moves toward a window border, is determined by the direction of the input object movement and may or may not be the same as that direction. Momentum-related dynamics of an inertial scrolling action may include the speed, duration, or both, of input object's engagement with the input device. An electronic device may be configured to support using other dynamics, such as the amount of pressure of an input object against an input device, to control the inertial scrolling distance. Unless specifically indicated, “dynamics of the user action” refers to “momentum-related dynamics”. Dynamics of inertial scrolling user action and dynamics of input object's engagement with input device (such as their respective speed) are closely related and therefore may be used interchangeably.

Initial Window Location: The location in the window, pointed at by the user when performing an inertial scrolling user action. In some embodiments, it may be the window location, which is pointed at by the user when the input object disengages from the input device. In some embodiments, it may be the window location, which is pointed at by the user when the input object engages with the input device.

Initial Pointed Document Area: Document area, which is displayed at the initial window location when inertial scrolling is initiated.

The first type, dynamics-independent, inertial scrolling (DIIS): inertial scrolling for a distance, independent of momentum-related dynamic parameters of the scrolling user action. The distance is instead based on display geometry, document structure, or user-defined settings, and may be:
(a) a distance between the window location pointed at by the user when the inertial scrolling user action is initiated and the window's border in the direction of the scrolling,
(b) a predetermined scrolling distance set by the user or inferred through machine-implemented means, or
(c) a distance needed to display a next information object in the document in the direction opposite to the scrolling direction. Variations: In some variations, a DIIS may be implemented such that only a maximum scroll distance is independent of dynamics, while shorter distances may be dynamics-dependent.

The second type, dynamics-dependent, inertial scrolling (DDIS): inertial scrolling, in which the scroll distance is determined by momentum-related dynamic parameters of the user gesture (e.g., speed), which parameters affect the perceived transfer of momentum to the displayed window content (e.g., a faster gesture may result in a longer inertial scrolling), and is not limited by a predefined value independent of momentum-related dynamic parameters of the user gesture.

Time Threshold: A configurable amount of time between a current scrolling and the immediately previous one, used to determine the type of the current scrolling.

### Overview of the Disclosed Method

The present invention teaches a method and apparatus, according to which the type of inertial scrolling caused by an inertial scrolling user action (ISUA) depends on the order of the ISUA in a block comprising either one ISUA or a series of consecutive ISUAs causing scrolling in generally the same direction. An ISUA is considered to continue a current series if it is performed in less than a predetermined amount of time (a “time threshold”) after the immediately preceding ISUA. According to the invention, a predetermined number of initial ISUAs in a block each cause a dynamics-independent inertial scrolling (DIIS), which is an inertial scrolling for a distance independent of the ISUA's momentum-related dynamics, such as speed and/or duration of the ISUA that causes the inertial scrolling. DIIS subtypes, disclosed in the invention, include:
(a) contact location-based inertial scrolling (LBS), which is scrolling for a distance between a user's contact location during the ISUA and a window border in the scrolling direction;
(b) predetermined distance scrolling (PDS), which is scrolling for a predetermined distance (defined, for instance, in geometrical units, such as millimeters, or in document units, such as lines of text); or
(c) next information object scrolling (NOS), which is scrolling to a next information object (such as a table, an image, a section, a chapter, or a blog post) in the scrolling direction, preferably an object not displayed in the window when an ISUA is initiated.

Furthermore, the following ISUA or ISUAs in the block, with order values exceeding the predetermined number of initial ISUAs, cause dynamic-dependent inertial scrolling (DDIS), in which scroll distance depends on the dynamics of the current ISUA (e.g., a faster ISUA may result in a longer inertial scrolling) and is not limited by a dynamics-independent predetermined value.

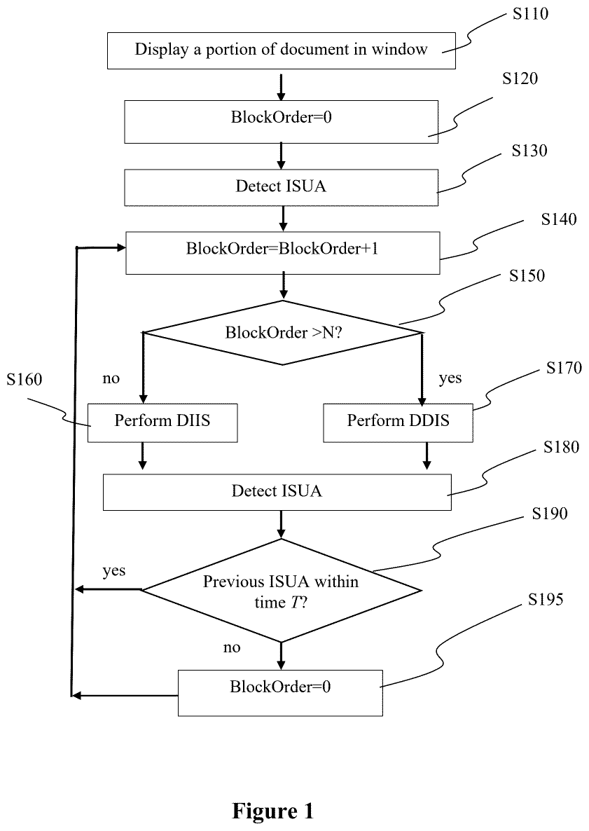

By way of example and not limitation, the method is schematically illustrated by FIG. 1. In the illustration, the first N (a predetermined number, let's assume “2”) ISUAs in a block cause DIIS and the ones that follow (with block order values larger than “N”) cause DDIS. At step S110, a document portion is displayed in a window, and at step S120, an indicator of ISUA's order in the current block, a BlockOrder counter, is set to zero. When an ISUA is detected at step S130, the BlockOrder counter is increased by “1” at S140, so that the block order indicator of the ISUA becomes “1”. At S150, it is established whether the value of the BlockOrder counter exceeds the predetermined number N. Since the current value does not exceed N, a DIIS is performed in step S160. When a next inertial scrolling is detected in S180, it is established, in S190, whether the immediately preceding ISUA took place within threshold time T. If not, then the new ISUA is not considered as continuing a series of consecutive ISUAs forming the current block and a new block is started by setting the BlockOrder count to zero in S195 and returning control to S140. If it is established at S190 that the new ISUA occurred within time T after detecting the previous ISUA, the new ISUA is considered as continuing the current series/block, and control is returned to S140, where the block order of the current ISUA is increased by “1” and becomes “2”. At S150 it is established that the new block order still does not exceed N, so a DIIS is performed at S160 in response to the new ISUA (the same or a different DIIS subtype as the one performed in response to the previous ISUA).

When a third ISUA is detected in S180 and, in S190, it is established that it is not preceded by previous ISUA for more than time T, the third ISUA is considered to continue the current series/block. Then control is passed to S140, where the ISUA's BlockOrder value becomes “3”. In S150, it is established that this new value exceeds N, so a DDIS is performed in response to the ISUA at S170. As to subsequent ISUAs, they may start a new block if they are detected for more that time T after the immediately preceding ISUA; otherwise, they continue the current series with increasingly higher block order values, and thus each would cause a DDIS.

In sum, FIG. 1 illustrates a possible implementation of a method, according to which, if a series of consecutive inertial scrolling user actions is performed, the first N of them will cause dynamics-independent inertial scrolling, and those that follow will cause dynamics-dependent inertial scrolling. It is understood that:

In different embodiments in the invention, different DIIS subtypes (including LBS, PDS, and NOS, described above), can be employed in response to ISUAs with block order numbers between 1 and N.

Different ways of measuring the time difference between an ISUA and the preceding inertial scrolling may be employed in different implementations of the invention. The moment of performing an ISUA may be defined as the time of input object's disengagement from, or engagement with, the input device when performing the ISUA. The moment of performing a preceding inertial scrolling may be defined as either the time of input object's disengagement from, or engagement with, the input device when performing the ISUA causing the preceding inertial scrolling, or as the moment when the preceding scrolling stops. Various ways of comparing these two moments can be used to measure the time difference between an ISUA and the preceding inertial scrolling. For instance, it can be measured as the time interval between: (a) moments of input object's engagement in the ISUA causing current scrolling and ISUA causing the previous inertial scrolling, or (b) moments of input object's disengagement in ISUAs causing, respectively, the current scrolling and previous inertial scrolling. Alternatively, it can be measured as the time difference between, on the one hand, the moment of input object's disengagement from, or engagement with, the input device when performing the ISUA causing the current inertial scrolling and, on the other hand, the moment when the content has scrolled during the latest previous inertial scrolling.

The value of threshold time T can be provided in apparatus's settings, it can be selected by the user, or it can be inferred from historical interaction data. It can also be determined through a combination of these methods. For instance, an initial empirically based default value (e.g., 700 ms) can be included in the settings and then, if needed, adjusted by the user or revised through monitoring the user's scrolling behavior. The time can also be individually established via calibration, e.g., by asking the user to perform a series of ISUAs immediately following one another and setting T to a minimal value exceeding most inter-scrolling intervals.

Consecutive DDIS-causing ISUAs in a series may have a compound effect on the distance and/or speed of their respective DDISs. For instance, each subsequent DDIS-causing ISUA may produce increasingly more momentum compared to previous ISUAs.

The method may employ a plurality of predefined time thresholds for deciding whether an ISUA continues a current series. For instance, different thresholds can be used in case of DDIS-causing ISUAs compared to DIIS-causing ISUAS, as well as for ISUAs causing different DIIS subtypes. Predetermined time threshold values may also decrease or increase with the increasing ISUAs block order values.

A new ISUAs may be detected when the inertial scrolling, caused by the previous ISUAs, has not been completed (i.e., the content still scrolls). In such cases, ISUAs block order numbers may increase with each consecutive ISUA to rapidly proceed to scrolling behavior corresponding to higher-order ISUAs in series. For instance, in case of the method illustrated by FIG. 1, a “triple-flick” would result in almost directly producing a DDIS. Alternatively, an incomplete scrolling may need to be completed before proceeding to a next scrolling.

### First, Second, and Third Embodiments

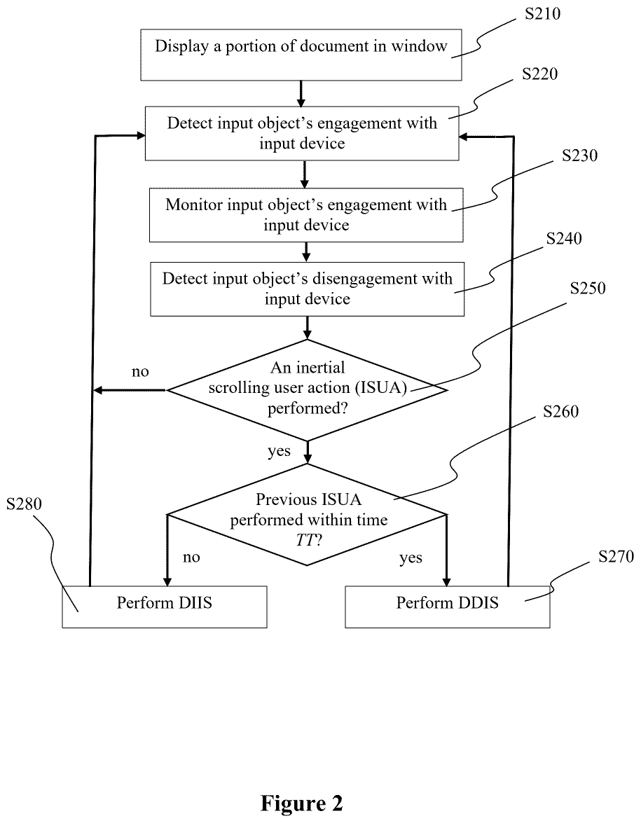

The first, second, and third embodiments of the invention are different implementations of a general method illustrated by FIG. 2. The method describes the selection of a DDIS or a DIIS in response to an ISUA depending on whether the ISUA is preceded by another ISUA taking place in the window within a predetermined amount of time (i.e., threshold time).

The method begins at step S210, where a portion of a document is displayed in a window. Steps S220 through S240 involve detecting and monitoring a user's engagement with a scrolling input device. If an ISUA is detected in step S250, and a previous ISUA occurred within a predefined time threshold TT in essentially the same direction (step S260), the system proceeds to step S270 to perform a DDIS., with the distance depending on such user action parameters as speed or duration. If no previous ISUA occurred within a predefined time threshold TT, the method proceeds to step S280 to perform a DIIS.

An advantage of the method, illustrated by FIG. 2, is that it intuitively provides the user with an inertial scrolling technique appropriate to the current purpose without the need for the user to explicitly request a switching from one scrolling technique to another. In continuous reading, there are usually longer time intervals between scrolling user actions because the user needs to read the newly displayed portion of a document before scrolling to another portion. If threshold time TT is sufficiently small, each inertial scrolling in continuous reading will not be preceded by another inertial scrolling taking place within threshold time TT. Therefore, each time the document will be scrolled for a predictable limited distance, which is suitable for continuous reading. If a long-distance scrolling is needed, the user may perform a series of scrolling user actions in essentially the same direction, quickly following one another with intervals smaller than threshold time TT. In such cases, only the first action would trigger limited-distance scrolling (which may not even be completed if a rapid “double-flick” is performed), while subsequent actions could result in greater scrolling distances.

In general, FIG. 2 discloses a method for assisting a user of an electronic device in viewing information, the electronic device comprising at least a processor, memory storing computer-executable instructions, a display having a window for displaying a portion of a document, and a scrolling input device, the method comprising:
detecting a first inertial scrolling user action, the user action comprising an engaging a scrolling input object with the scrolling input device and subsequent disengaging the input object from the input device;
wherein detecting the first inertial scrolling user action comprises identifying at least: a direction of the user action and at least one dynamic parameter selected from the group consisting of at least: speed, acceleration or deceleration, and duration of the user action;
determining whether a second inertial scrolling of the document occurred in the window within a first threshold time prior to the first inertial scrolling user action and in essentially the same direction;
if such a second inertial scrolling occurred within the threshold time, performing a DDIS in direction determined by the identified user action direction, wherein a scrolling distance is based on at least one of the dynamic parameters;
otherwise, performing a DIIS in direction determined by the identified user action direction, wherein the scrolling distance is one from the group consisting of at least: (a) a distance between either an engagement or the disengagement window location and a window border in the scrolling direction; (b) a predetermined scrolling distance; and (c) a distance to a next information object in the document in direction opposite to the scrolling direction.

### First Embodiment

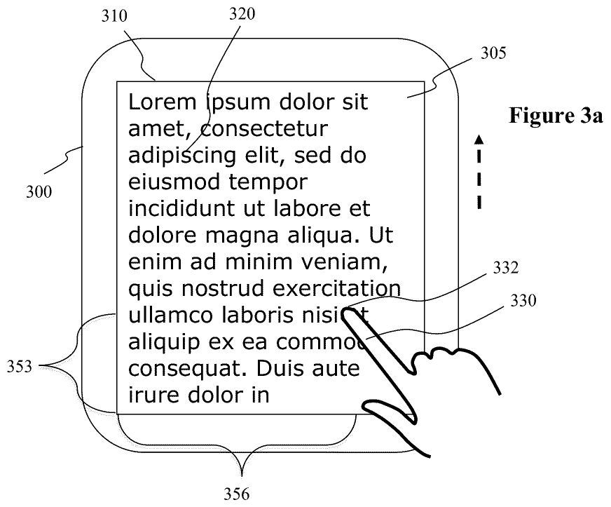

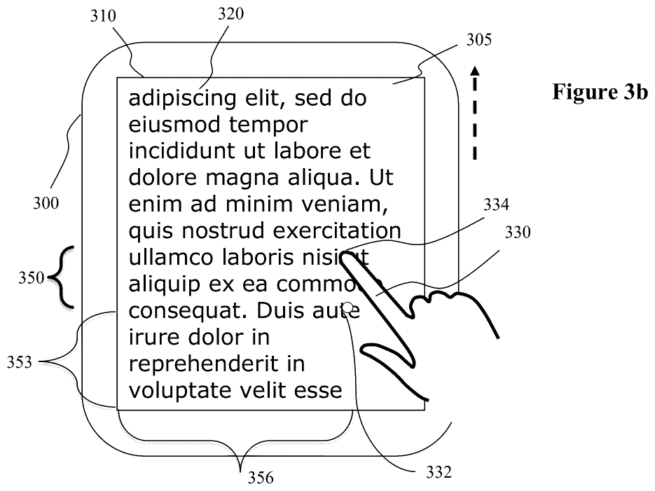

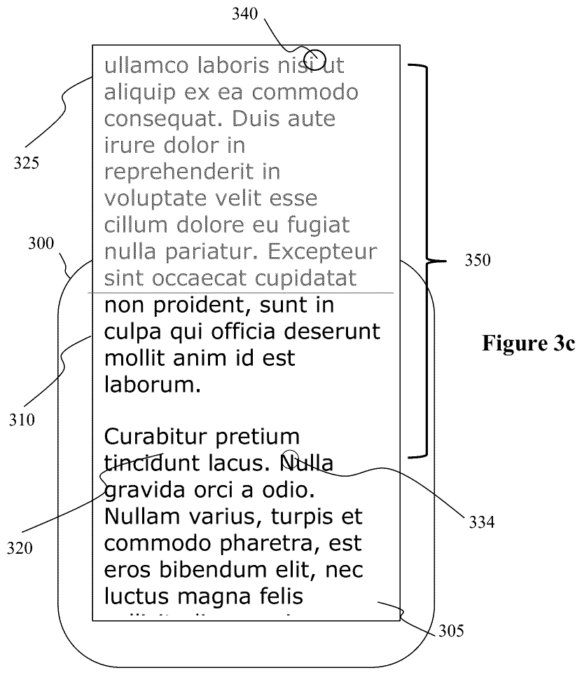

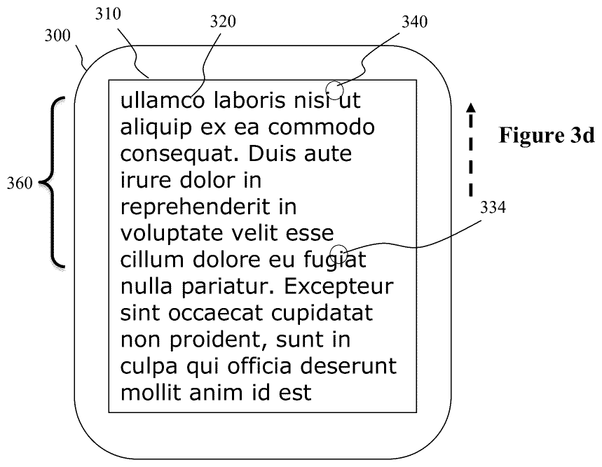

FIGS. 3-6 illustrate the first embodiment of the invention, in which the DIIS distance is a distance between (a) the window location, pointed at by the user at the time when the input object disengages from/engages with the input device to produce inertial scrolling (the “initial window location”) and (b) a window border in the direction of the scrolling.
FIGS. 3a through 3d illustrate a variation of the first embodiment implemented using a touchscreen. Electronic device (e.g., a tablet computer) 300 has touch screen 305, which is a combination of an input device and a display. Touch screen 305 displays window 310, which takes the entire space of touchscreen 305 and displays document 320. Only a portion of document 320 can be displayed in window 310. To bring to view other portions of the document the user needs to scroll the document by performing a scrolling gesture, which gesture comprises moving input object 330 (a finger), and engaging and disengaging the input object with the input device (touch screen 305).

FIGS. 3a and 3b show the moments of the beginning and the end of the engagement of input object 330 with touchscreen 305. FIG. 3a shows window 310, displaying a first portion of document image 320, at the moment when input object 330 gets in contact with touch screen 305 in window location 332 (the “engagement location”) initiating an inertial scrolling user action (ISUA). Window location 332 is located higher than (by distance 353) and to the right of (by distance 356) the bottom left corner of window 310. Window location 332 displays an area of document 320 approximately between “nisi” and “ut”.

FIG. 3b shows window 310 displaying a second portion of document 320, partly overlapping with the first portion (shown in FIG. 3a). Displaying the second portion has been caused by moving input object 330 upward for distance 350, while keeping contact between touch screen 305 and input object 330. As a result, document 320 scrolls two lines up, so the top two lines of the first portion are no longer visible, and two new lines are displayed at the bottom of window 310. Object 330 moves upward to window location 334, and there disengages from (breaks contact with) display 305. If parameters of the touch gesture (i.e., the movement of input object 330 when in contact with touchscreen 305), such as its speed and duration, cause document 320 to continue scrolling after the disengagement, a performed ISUA is detected. In this case, the moment of time of the disengagement is the moment of time when inertial scrolling is considered to be initiated by the user. In the context of the present variation of the first embodiment, window location 334, the “disengagement location”, is the “initial window location”. Document image area 340 shown in proximity of location 334 at the moment of disengagement is the “initial pointed document area”.

The type of inertial scrolling of document 320, performed in response to the ISUA, depends on whether a previous inertial scrolling in essentially the same direction took place in window 310 within a threshold time T1.

FIG. 3c shows DDIS, dynamics-dependent inertial scrolling where the document continues to scroll depending on, e.g., the speed of user's gesture, while FIG. 3d demonstrates a DIIS, dynamics-independent, inertial scrolling. The DDIS, illustrated by FIG. 3c, is performed if a previous inertial scrolling took place within time threshold T1. In this case, after the input object's disengagement, document 320 continues to scroll, which scrolling slows down and eventually stops. The distance of the scrolling depends on the dynamics (e.g., speed, acceleration, and contact duration) of the ISUA. FIG. 3c shows inertial scrolling for distance 350, which causes the “initial pointed document area” 340 move beyond the top border of window 310 and disappear from view.

FIG. 3d illustrates a DIIS, which takes place after input object's disengagement if no previous inertial scrolling in essentially the same direction took place in window 310 within threshold time T1. Document 320 scrolls for the distance between initial window location 334 and top border of window 310. The scrolling stops when initial pointed document area reaches the window's top border. FIG. 3d shows window 310 displaying a third portion of document 320, partly overlapping with the first and the second portions shown in FIGS. 3a and 3b. The third portion is displayed in window 310 as a result of inertial scrolling of the second portion of document 320 (shown in FIG. 3b) towards the top border of window 310 by distance 360 (approximately 6 lines of text). After moving for that distance, the inertial scrolling stops. The scrolling moves the “initial pointed document area” 340 from initial window location 334 to top border of window 310.

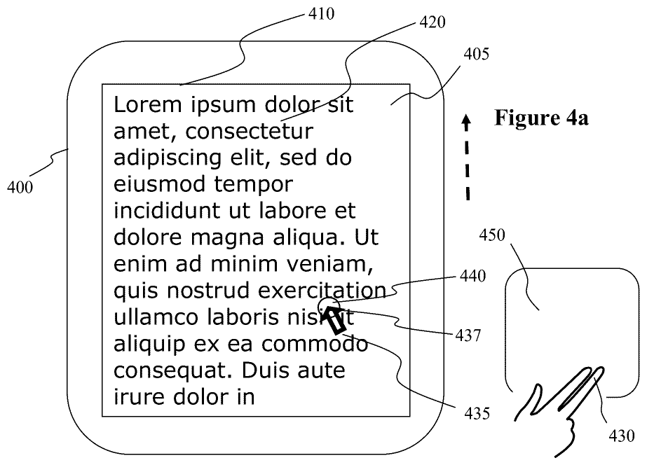

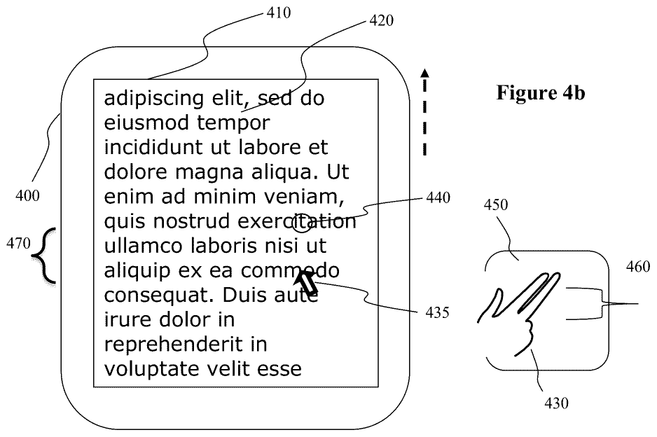

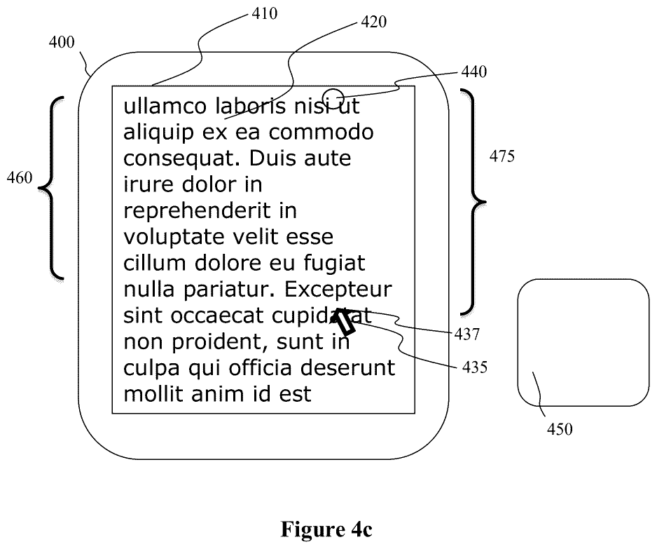

FIG. 4 shows a second variation of the first embodiment that uses a touch pad as the scrolling input device. FIG. 4a shows electronic device 400, which has display 405 showing window 410. Window 410 displays a first portion of document 420 and screen pointer 435. Document 420 can be scrolled in window 410 by engaging input object 430 (user's two fingers) with touch pad 450. FIG. 4a shows the moment of input object 430 making contact with touch pad 450. At that moment screen pointer 435 points to window location 437 (“engagement window location”), in proximity of which location area 440 of document 420 is displayed. Area 440 is located in the upper part of the fourth line from bottom, between “nisi” and “ut”.

FIG. 4b shows window 410, in which input object 430, while engaging with touch pad 450, has moved up for distance 460. The movement has made document 420, along with initial pointed document area 440, scroll up for distance 470 to a second portion of document 420. The direction of the input object movement and the direction of scrolling do not necessarily coincide. In some devices, systems, or applications, window content may scroll, for instance, in a direction opposite or orthogonal to the movement of the input object.

FIG. 4b shows that as a result of input object's movement, the content of window 410 has scrolled up for about two lines of text so that the top two lines of the first portion are no longer visible, and two new lines are displayed at the bottom of window 410. FIG. 4b shows the moment of the disengagement of input object 430 from touch pad 450.

After the disengagement, parameters of the touch gesture during the engagement of input object 430 with touch pad 450, such as speed and duration, may cause document 420 to continue scrolling after the disengagement. In that case, an ISUA is detected. The type of inertial document scrolling performed in response to the ISUA depends on whether a previous inertial scrolling (in essentially the same direction) took place in window 410 within a threshold time T2.

If a previous inertial scrolling took place within threshold time T2, a DDIS is performed (not shown in FIG. 4). After input object's disengagement, document 420 continues to scroll and the scrolling eventually slows down and stops.

FIG. 4c illustrates a DIIS, performed if no previous inertial scrolling took place in window 410 within threshold T2. In that case an inertial scrolling of the document is performed for a distance between disengagement location and window border in the direction of scrolling. Since the disengagement took place after the document scrolled for distance 470 from engagement window location 437, the distance of the DIIS is distance 460, which is calculated as a difference between (a) the distance 475 between the engagement window location 437 and top border of window 410, and (b) distance 470, for which distance the document scrolled between the moments of input object's 430 engagement with, and disengagement from, input device 450. FIG. 4c shows window 410 displaying a third portion of document 420, partly overlapping with the first and the second portions shown in FIGS. 4a and 4b. The third portion is displayed in window 410 as a result of inertial scrolling of document 420 toward the top border of window 410 by additionally scrolling for distance 465 compared to the portion shown in FIG. 4b.

In general, in case of the second variation of the first embodiment, the distance of second-type inertial scrolling can be calculated as

$$D ( is ) = D ( p - b ) - D ( e - d )$$

where D(is) is the distance of inertial scrolling, D(p-b) is the distance between the pointer location and window border in the direction of scrolling, and D(e-d) is the distance, for which window content scrolls between input object's engagement with and disengagement from the input device.

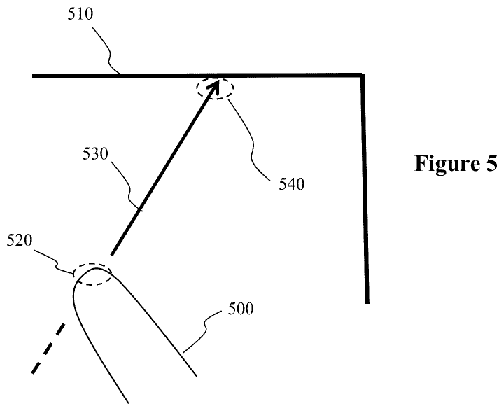

It is understood that a document can be scrolled in different directions: not only vertically (up, down) as illustrated by FIGS. 3 and 4, but also horizontally (left, right), or in a direction having both a vertical and a horizontal component. The latter, in the case of the first variation of the first embodiment, is illustrated by FIG. 5.

FIG. 5 depicts a variation of the first embodiment where scrolling occurs in a direction 530 with both vertical and horizontal components. The input object 500 moves diagonally across window 510 and disengages at point 520. The document content continues scrolling in the same diagonal direction until the initial window location reaches window border 540.

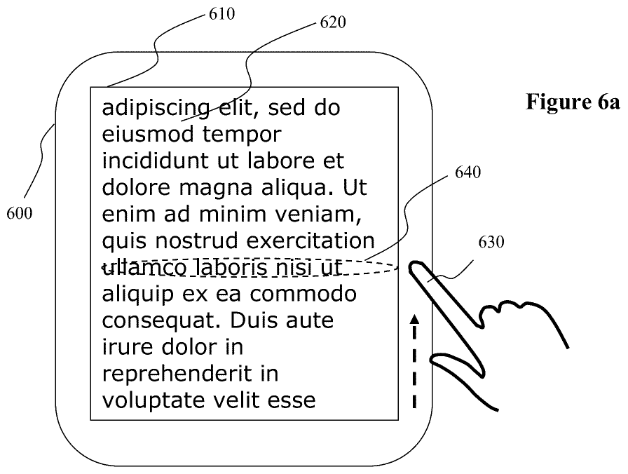

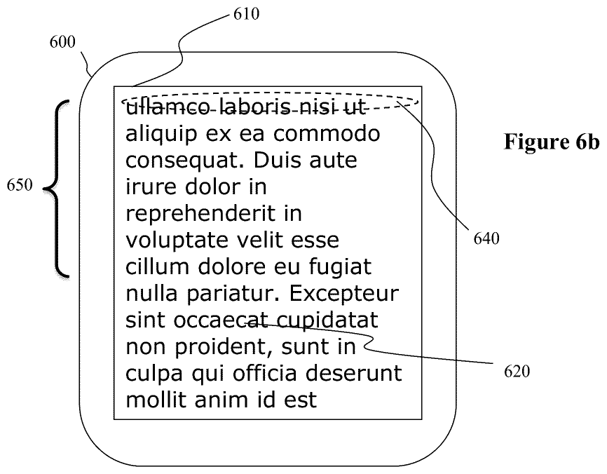

FIG. 6 shows a third variation of the first embodiment of the invention. In this variation, the input device is an input area adjacent to the display, namely, located along the right edge of the device 600. The input device can be of the same height as the display and placed at the same level as the display, so the input device's vertical coordinate of a point, selected on the input device, would directly correspond to a vertical window coordinate of the display image area to the left of the selected input device point.

Electronic device 600 includes display window 610 displaying a first portion of document 620. Document 620 can be scrolled vertically by sliding input object 630 along the right side of device 600, just outside display window 610. FIG. 6a shows the moment when input object 630, after sliding vertically up along the right side of device 600, breaks contact with device 600 to initiate inertial scrolling of document 620. Horizontal area 640 of document 620 is an “initial pointed document area”, displayed at substantially a level corresponding to the location of input object 630 at the moment when input object 630 breaks contact with device 600. Area 640 takes up the entire width of display window 610. Alternatively (not shown) an “initial pointed document area” can be a limited size screen object (e.g., a circle) having the same vertical window coordinate as area 640. FIG. 6b shows the end moment of a DIIS taking place if there is no preceding same-direction ISUA within a time threshold. The scrolling ends when area 640 moves for distance 650 and reaches the top border of window 610.

In general, the first embodiment of the invention is an embodiment, wherein an LBS subtype of DIIS is performed in response to an ISUA in a direction determined by, and possibly coinciding with, a direction of said ISUA, and wherein a distance of said second-type inertial scrolling being a distance between an initial window location and a window border in said direction of said first scrolling user action. Although location-based inertial scrolling is known in the art, including in a related application by the present inventor, the present invention is directed to a method that automatically selects among multiple scrolling behaviors—including but not limited to location-based scrolling—based on temporal proximity of recent user interactions. This conditional selection mechanism forms a key inventive feature of the present disclosure.

### Second Embodiment

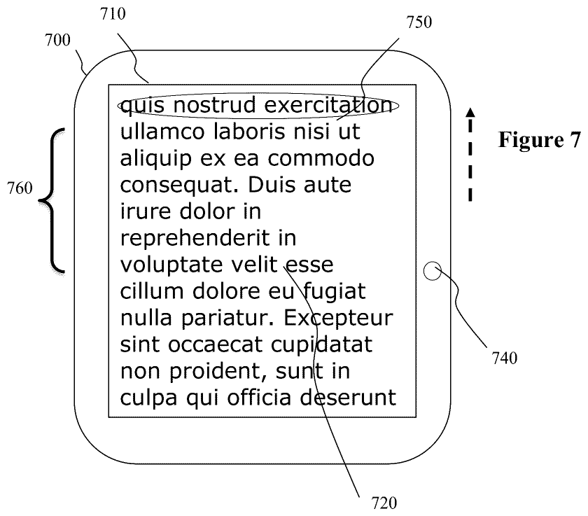

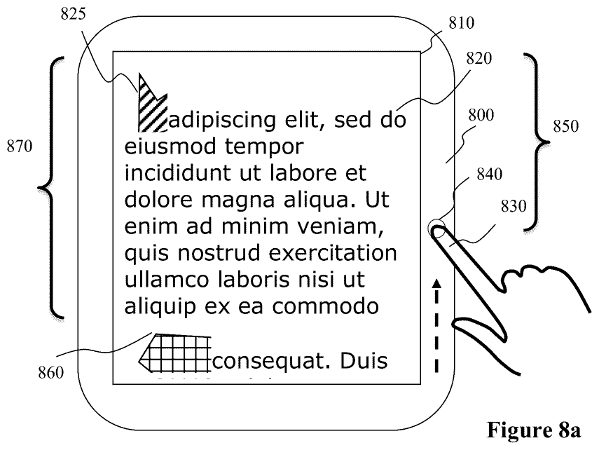

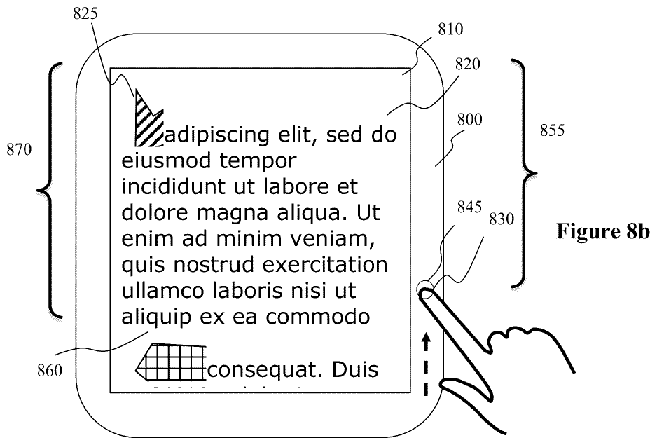

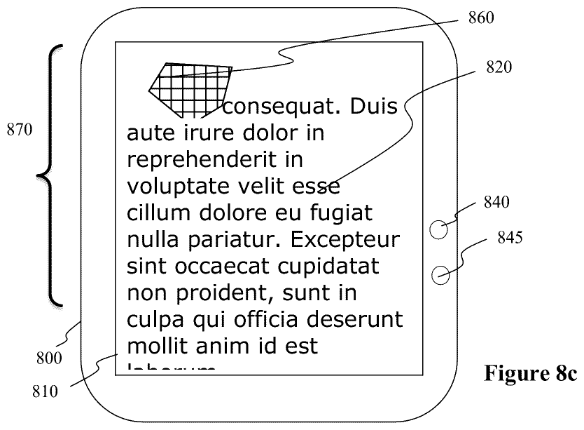

FIG. 8 illustrates the second embodiment of the invention by showing a case, in which the PDS subtype of DIIS is employed if there is no preceding ISUA within a threshold time. If there is a preceding ISUA within a threshold time, a DDIS is performed, which case is not shown in FIG. 7.

FIG. 7 shows a variation of the second embodiment using an edge-based input method similar to those shown in FIG. 6. Electronic device 700 includes display window 710 displaying a first portion of document 720. Document 720 can be scrolled vertically by sliding an input object, such as user's finger along the right edge of device 700, just outside display window 710. FIG. 7 shows the moment after completing an inertial scrolling of document 720, which scrolling is caused by an input object sliding vertically up along the right side of device 700 and then disengaging with device 700 at location 740. Horizontal area 750, an “initial pointed document area”, has moved up for distance 760 as a result of the inertial document scrolling. There has been no previous inertial scrolling in the window within threshold time, and distance 760 is a predetermined distance.

According to the embodiment, the distance of DIIS is distance 760, independent of the speed of the input object during its engagement with the input device and selected irrespectively of the disengagement location. If disengagement location is not 740, but rather a location, which is higher or lower than location 740, the distance of the DIIS will still be 760.

The predetermined distance of a PDS subtype of DIIS can be different for different scrolling dimensions (e.g., scrolling up vs. scrolling down). Such differences can be pre-set as either absolute or relevant values (e.g., 5 cm, ⅓ of the window height, 19 lines of text, etc.) or defined by the user (e.g., by choosing an appropriate setting for inertial scrolling. Furthermore, they can be inferred using machine-implemented means, for instance, by first collecting data about user's scrolling behavior in conventional scrolling and identifying a typical distance, for which the user is expected to scroll a document from a current portion to an adjacent portion (e.g., by calculating a median). Such typical distances can be inferred separately for different scrolling directions. When such typical distances are identified, the user may be notified and suggested to switch from conventional scrolling to a contextual scrolling according to the present invention.

It is understood that other variations of the second embodiment, such as two-dimensional touchscreen-based scrolling or scrolling using a touch pad, by analogy to the variations of the first embodiment, described above, are covered by the invention.

Generally, the second embodiment of the invention is an embodiment implementing the PDS subtype of DIIS, wherein a distance of DIIS is a predetermined distance.

### Third Embodiment

FIGS. 8a through 8c illustrate the third embodiment, in which the NOS subtype of DIIS is implemented, by showing an inertial scrolling that moves the document to the next information object in the direction opposite to the scrolling direction, if there is no preceding ISUA within a time threshold. If there is a preceding ISUA within a time threshold, a DDIS is performed, which case is not shown in FIG. 8.

Electronic device 800 includes display window 810 displaying a first portion of document 820. Document 820 includes first image 825 and second image 860, separated by distance 870. FIG. 8a shown input objects'830 disengagement at location 840. FIG. 8B shows an alternative ISUA, in which input object 830 is disengaged at location 845. In both cases, as shown in FIG. 8C, document 820 scrolls such that the next object, image 860, is moved to be displayed at the top of window 810.

It is understood that different types of information objects, such as tables, paragraphs, sections, social media posts, and so forth, can be selected, individually or in addition to each other, as determining the distance of a NOS subtype of DIIS according to the third embodiment. The selection can be either predetermined or flexibly defined by various categories of users (such as text authors and readers), for instance by adding anchor points to a document or setting scrolling options in the setting of an electronic device or a digital application. The next information object may be identified by locating the next content element beyond the current scroll position using structure-aware cues such as HTML tags (<p>, <h2>), XML elements (<para>, <figure>), or document metadata (e.g., styles, anchors, or table-of-contents entries). In unstructured or image-based documents, visual segmentation or heuristic rules may be applied to infer object boundaries. Machine learning models may also be employed to dynamically segment and classify document regions based on content and layout.

The user can select, e.g., by marking options in a dialog box, their preference regarding what types of information objects can be employed as anchor points in the “next object” variation of second-type inertial scrolling. Alternatively, a user's historical interaction data can be used to infer what objects the user naturally tend to scroll to.

It is further understood that scrolling to the next information object in the direction opposite to the scrolling direction, according to the third embodiment, may be a scrolling to the first object, not displayed, or not completely displayed before the scrolling. For instance, a scrolling to view a table, which is partly displayed in window so that the first row is at the top of the window, the first three rows are completely in view, and the fourth row is displayed partly, a NOS subtype of DIIS may bring the fourth row to the top of the window. Implementing this rule in case of the example in FIG. 8, would mean scrolling up to bring to pass image 860, as it is completely displayed before scrolling, and bring to view a potential next image presented in document 820.

The distance of a NOS subtype of DIIS may be limited to a scrolling to an adjacent portion of the scrolled document, so that the scrolling does not skip a window content located between the portion displayed before a certain scrolling and the portion displayed after the scrolling.

Generally, the third embodiment of the invention is an embodiment, wherein a NOS subtype of DIIS is performed in response to an ISUA for a distance required to view a next information object in the direction opposite to the DIIS direction.

### Fourth Embodiment: Combining DIIS Subtypes

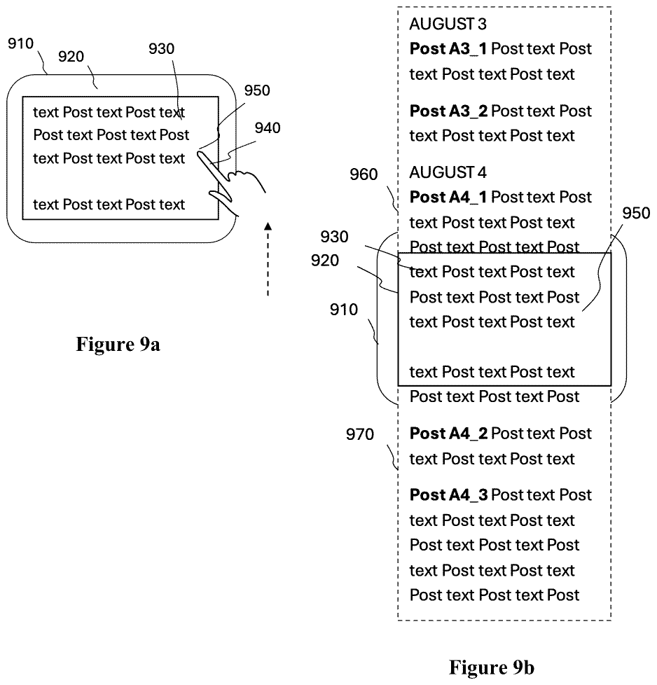

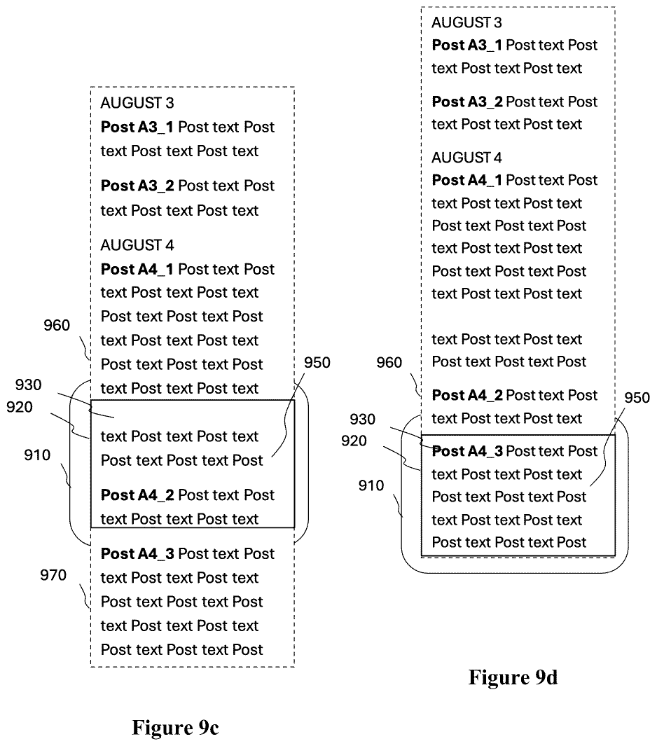

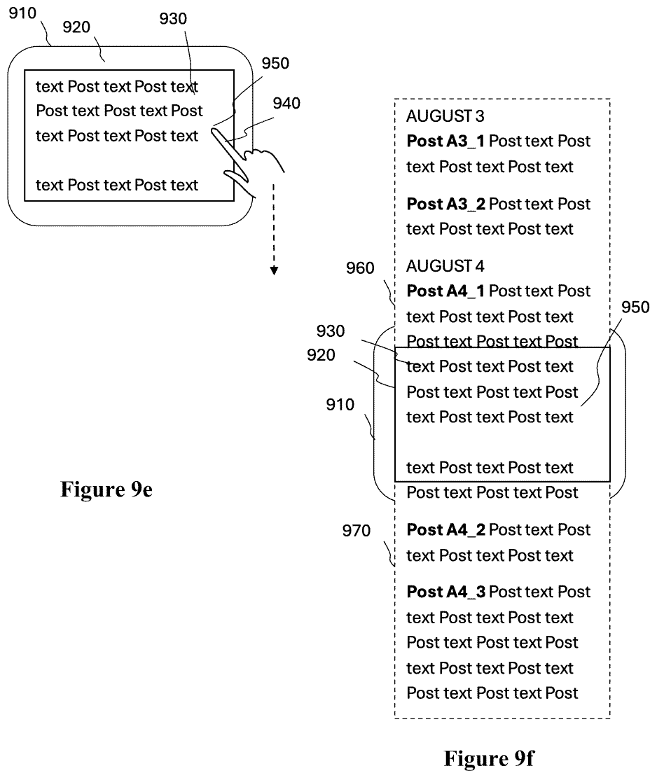

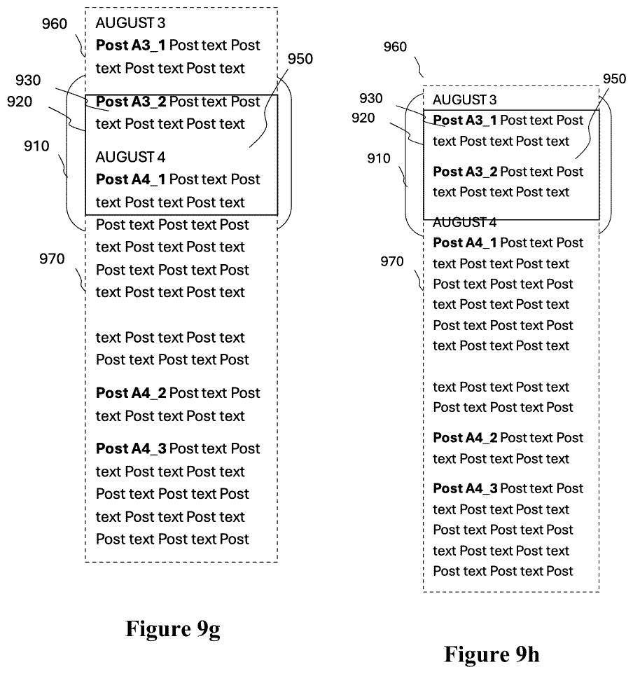

The three DIIS subtypes disclosed in the invention, LBS, PDS, and NOS, described above can be combined with one another. More than one of them can be used in a same implementation of the invention, for instance, to collectively determine the distance of DIIS in each particular case, based on a predefined set of rules or priorities or otherwise best conform to user preferences. Furthermore, if several initial ISUAs in a block are each causing a DIIS (see FIG. 1), ISUAs with different block order may trigger different subtypes of DIIS. These aspects of the invention are illustrated by FIG. 9.

FIG. 9 shows an embodiment of the invention, in which two initial ISUAs in a block cause DIIS, while a third and potential further ISUAs in the block cause DDIS. The DIIS subtypes caused by ISUAs in different scrolling directions are different: when scrolling the content up (to view further portions), the first ISUA cause a PDS and the second causes NOS, while when scrolling the content down (to view previous portions), each of two initial ISUAs causes a NOS. FIG. 9 only shows instances of DIIS, each taking place in response to an ISUA if there is no preceding ISUA in essentially the same direction within a time threshold. If there is such preceding ISUA within a time threshold, a DDIS is performed, which cases are not shown in FIG. 9.

FIG. 9 shows electronic device 910, such as a smartphone, having window 920, which displays document 930 comprising a set of texts (“posts”), organized in a chronological order. FIG. 9a shows a simple view of device 910 displaying a portion of document 930. FIG. 9b shows an augmented view of device 910 displaying the same portion of document 930, which view also shows non-displayed portions 960 and 970 of document 930, which are located, respectively, above and below the visible portion.

FIGS. 9a and 9b show a moment before two consecutive ISUAs are performed. In each ISUA object 940 engages with display window 920 in location 950 to cause an upwards inertial scrolling. FIGS. 9c and 9d show the resulting views of, respectively, the first and the second ISUAs. FIG. 9c shows document 930, which, after the first ISUA causing a PDS was performed, has scrolled up for predetermined distance 980 (about 3 lines of text). FIG. 9d shows document 930, which, after the second ISUA causing a NOS was performed, has scrolled up to display a post entitled Post A4_3, placing the beginning of the post at the top of window 920.

FIGS. 9e and 9f, similarly to FIGS. 9a and 9b, show a moment before two consecutive ISUAs are performed by engaging object 940 with display window 920 in location 950. The difference is that the ISUAs are about to cause a downward inertial scrolling of window content. FIGS. 9g and 9h show the resulting views of, respectively, the first and the second ISUAs. FIG. 9g shows document 930, which, after the first ISUA causing a NOS was performed, has scrolled down to display a post entitled Post A3_2, placing the beginning of the post at the top of window 920. FIG. 9d shows document 930, which, after the second ISUA, also causing a NOS, was performed, has scrolled further down to display a post entitled Post A3_1, placing the beginning of the post at the top of window 920.

Potential advantage of the embodiment illustrated by FIG. 9 is that it may selectively address user's preferences, related to different scrolling directions: continuous reading of a post (which may be better supported by PDS) and looking up previous posts (which may be better supported by NOS). In addition, the user may choose to perform a series of consecutive ISUAs comprising a variable number of ISUAs, to more successfully achieve different goals, such as (in case of scrolling the content up): continuous reading (single flick to cause PDS), moving to a next information object (double-flick to cause NOS), or browsing (triple-flick to cause DDIS).

### Ramifications and Variations

Several modifications of the embodiments described above, as well as combinations of the modifications, are covered by the present invention:

While the scrolling input devices shown above are touch screen, touchpad and an off-display area, the invention applies to other types of devices that can be used to perform scrolling actions, including, but not limited to, scroll wheels, joysticks, trackpads, mid-air gesture recognition devices, or other alternative scrolling input device. In these cases, the direction and distance of scrolling are determined by the parameters of the user action, such as direction, distance, time, and speed. Particularly, in case of a scroll wheel engagement/disengagement times would be the times of the start/end of the movement of the wheel (pressure). If a document scrolling is achieved by performing a mid-air scrolling gesture over the surface of a screen without touching the screen, the “initial window location” can be the window location that the user explicitly or implicitly points to at the moment, when an inertial scrolling is initiated by the user. For instance, an “initial window location” can be the area of the window in closest proximity to the input object (such as user's fingers) when pointing toward the input device (e.g., a display). An input object disengagement from the input device can be indicated, for instance, by rapidly increasing the distance between the input object and the device.

As illustrated by FIGS. 3-6 an ISUA may involve continuous-contact non-inertial scrolling during the input object's engagement with the input device. It is understood that input object's engagement with input device during an ISUA, for instance, because of its short duration, may also involve no scrolling during the engagement. In such cases a window content may not start to scroll until after the input object disengages from the input device. Furthermore, if a non-inertial scrolling does take place during an ISUA (i.e., during the time between the input object's engagement with, and disengagement from, the input device), the attributes of the input object's movement may be differently mapped to attributes (e.g., speed and distance) of the non-inertial scrolling.

The disclosed DIIS subtypes (LBS, PDS, NOS) are provided by way of example and not limitation. A dynamics-independent inertial scroll may be determined by any rule, algorithm, or heuristic that produces a scroll distance not governed by the momentum-related dynamics of the initiating user action.

Threshold times for selectively initiating a DDIS or DIIS may be different for scrolling in different directions (e.g., scrolling up vs. scrolling down). Furthermore, a threshold time logic shown in FIGS. 1-2 can only be applicable to consecutive scrolling performed in the same direction. For instance, if an upward inertial scrolling is immediately (e.g., after 300 ms) followed by an upward ISUA, the inertial scrolling resulting from the user action could be a DIIS, while if an upward inertial scrolling is immediately (e.g., after 300 ms) followed by a downward inertial scrolling user action, the inertial scrolling resulting from the user action may be a DDIS.

An initial pointed document area may be temporarily highlighted during scrolling, either continuously, starting from the engagement of the input object with the input device, or only after the engagement of the input object from the input device. Various visual cues, having a variety of shapes, sizes, colors, and dynamics, can be used for used for the highlighting. For instance, a cue can be of the size of the tip of an input object or a smallest area, which can still be clearly visible when a highlighting visual cue is enabled. Means for managing the highlighting's parameters (including enabling or disabling a highlighting), such as a possibility to choose appropriate settings, can be provided to the user. A highlighting may fade away and eventually disappear as the user becomes familiar with the second-type inertial scrolling.

Visual effects indicating that initial pointed document area has reached a window border may or may not be used; if they are used, various types of visual effects can be employed.

The speed of a DIIS can be set higher or lower. For instance, if a PDS subtype of DIIS is implemented so that any ISUAs, even low-dynamics ones, causes inertial scrolling for the entire predetermined distance, the speed of the scrolling may be selected and/or adjusted depending on user's needs and preferences. DIIS can be implemented so that only the maximum scrolling distance is independent of the dynamics of the scrolling user action, while shorter distances may be dynamics-dependent. For instance, a PDS subtype of DIIS may be implemented so that a scrolling distance is dynamics-dependent as long as it does not exceed the predetermined distance. After the predetermined distance has been reached, increased dynamics (e.g., faster ISUAs) will not result in longer scrolling distances. Similar logics can be applied to other embodiments: in general, ISUA's dynamics may affect the scrolling distance if the ISUA causes a shorter-distance inertial scrolling, which stops before moving window content for the maximum potential length of the selected DIIS.

In addition to the speed and duration of an input object's engagement with an input device, other parameters of the inertial scrolling user action can be used to determine the distance, speed, and deceleration of document's inertial scrolling. Such additional parameters may include, for instance, input object's acceleration, amount and dynamics of input object's pressure against the input device, or objective indicators of user's effort (e.g., muscle tension, facial expression) when performing an inertial scrolling user action (e.g., with more pressure or higher indicators of user's effort resulting in longer and/or faster inertial scrolling).

An ongoing inertial scrolling can be stopped, or a new scrolling action can be initiated, if the user performs a user action using an input device (e.g., touches the display) the previous inertial scrolling stops (e.g., in case of LBS, before an “initial pointed document area” reaches a border of the window). If a new action is initiated, the new scrolling may start from the position, in which the document is located in the window at the moment when the new action is detected. Alternatively, the new scrolling may start from the position, in which the document would be located in the window if the previous scrolling were completed.

In the LBS subtype of DIIS, an inertial scrolling may be stopped when different parts of an “initial pointed document area”, for instance, its center point or an outer edge, reach a border of the window, or an “initial pointed document area” may stop at a certain offset distance before reaching the border.

1. A computer-implemented method for supporting inertial scrolling of content displayed in a window on an electronic device, the electronic device comprising at least a processor, memory, a display, and a scrolling input device, the method comprising:
detecting a current inertial scrolling user action (ISUA), the ISUA comprising engagement of an input object with the scrolling input device and subsequent disengagement of the input object from the scrolling input device;
determining a scrolling direction associated with the current ISUA;
determining whether an inertial scrolling of the content, caused by a preceding ISUA, occurred within a predetermined time threshold before the current ISUA and in substantially the same scrolling direction;
when no such inertial scrolling occurred within the predetermined time threshold, performing a dynamics-independent inertial scrolling (DIIS) of the content in the determined scrolling direction; and
when such inertial scrolling occurred within the predetermined time threshold, performing a dynamics-dependent inertial scrolling (DDIS) of the content in the determined scrolling direction,
wherein a scrolling distance of the DIIS is determined independently of momentum-related dynamic parameters of the current ISUA, and
wherein a scrolling distance of the DDIS depends on at least one momentum-related dynamic parameter of the current ISUA.

2. An electronic device comprising:
a display having a window configured to display a portion of a document;
a scrolling input device;
at least one processor; and
memory storing computer-executable instructions that, when executed by the processor, cause the electronic device to perform the method of claim 1.

3. The method of claim 1, wherein the predetermined time threshold is measured between at least one of:
(a) disengagement times of consecutive ISUAs,
(b) engagement times of consecutive ISUAs, or
(c) an end of inertial scrolling caused by the preceding ISUA and an engagement or disengagement of the current ISUA.

4. The method of claim 1, wherein the DIIS comprises scrolling the content for a distance between an initial window location pointed at by the user during the current ISUA and a border of the window in the scrolling direction.

5. The method of claim 4, wherein the initial window location corresponds to a window location pointed at by the user at one of:
(a) engagement of the input object with the scrolling input device, or
(b) disengagement of the input object from the scrolling input device.

6. The method of claim 1, wherein the DIIS comprises scrolling the content for a predetermined distance independent of a disengagement location of the input object.

7. The method of claim 6, wherein the predetermined distance differs for different scrolling directions.

8. The method of claim 1, wherein the DIIS comprises scrolling the content to display a next information object that was not displayed in the window prior to the current ISUA.

9. The method of claim 8, wherein the next information object is selected from the group consisting of a paragraph, section, image, table, post, or other structured document element.

10. The method of claim 1, wherein a DIIS subtype applied for scrolling in a first direction differs from a DIIS subtype applied for scrolling in an opposite direction.

11. The method of claim 1, wherein momentum-related dynamic parameters of the current ISUA affect a scrolling distance of the DIIS up to a maximum distance and do not increase the scrolling distance beyond the maximum distance.

12. The method of claim 1, wherein different predetermined time thresholds are used for different scrolling directions or different DIIS subtypes.

13. The method of claim 1, wherein the current ISUA is detected before inertial scrolling caused by the preceding ISUA has completed.

14. The method of claim 1, wherein the scrolling input device comprises at least one of a touch screen, touch pad, scroll wheel, joystick, off-display input area, or mid-air gesture sensor.

15. The method of claim 1, wherein the scrolling input device is distinct from the display.

16. A computer-implemented method for supporting inertial scrolling of
content displayed in a window on an electronic device, the electronic device comprising at least a processor, memory, a display, and a scrolling input device, the method comprising:
detecting an inertial scrolling user action (ISUA);
assigning a block order value to the detected ISUA, the block order value indicating an order of the detected ISUA within a block of one or more ISUAs performed in substantially a same scrolling direction;
determining whether the detected ISUA belongs to a same block as a preceding ISUA based on whether the detected ISUA occurs within a predetermined time threshold after the preceding ISUA;
when the block order value of the detected ISUA does not exceed a predetermined number of initial block orders, performing a dynamics-independent inertial scrolling (DIIS) of the content in a scrolling direction determined by the detected ISUA; and
when the block order value of the detected ISUA exceeds the predetermined number of initial block orders, performing a dynamics-dependent inertial scrolling (DDIS) of the content in the scrolling direction,
wherein a scrolling distance of the DIIS is determined independently of momentum-related dynamic parameters of the detected ISUA, and
wherein a scrolling distance of the DDIS depends on at least one momentum-related dynamic parameter of the detected ISUA.

17. The method of claim 16, wherein the block is reset when no ISUA is detected within the predetermined time threshold.
